(19) United States
(12) Patent Application Publication
(10) Pub. No.: US 2006/0198545 A1
(43) Pub. Date: Sep. 7, 2006

(54) Thin display stand with a sub-woofer

(75) Inventors: Li-Chun Che, Taipei (TW); Cheng-Sheng Chang, Taipei (TW); Te-Tsang Wang, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/248,174

(22) Filed: Oct. 13, 2005

(30) Foreign Application Priority Data
Mar. 1, 2005 (TW) 94106128

(51) Int. Cl. H04R 5/02

(52) U.S. Cl. 381/388; 381/306; 381/333

(57) ABSTRACT

A thin display stand with a sub-woofer includes a sub-woofer, a stand body, a damper and a fastener. The damper separates the sub-woofer and the stand body and is coupled with both, so that the sub-woofer and the stand body are prevented from contacting each other, and a shock from the sub-woofer is absorbed by the damper. The fastener is adapted for fixing the damper.

### RELATED APPLICATIONS

The present application is based on, and claims priority from, Taiwan Application Serial Number 94106128, filed Mar. 1, 2005, the disclosure of which is hereby incorporated by reference herein in its entirety.

### BACKGROUND

1. Field of Invention

The present invention relates to a stand with a sub-woofer. More particularly, the present invention relates to a thin display stand with a sub-woofer.

2. Description of Related Art

As living standards improve, people demand entertainment with higher and higher video and audio qualities, such as those provided by a sub-woofer of a stereo system. In a stereo system, a sub-woofer provides better bass effect but occupies extra space and is typically located externally to the main stereo system.

Thin displays, such as LCD and plasma-display televisions, have become more and more popular. A product increases considerably in size if a sub-woofer is built in. On the other hand, if a trade-off design is selected, the achieved bass effect is not good enough and an external apparatus is often considered. The external sub-woofer is inconvenient since it requires extra space. Furthermore, if a sub-woofer is built into a thin display, shocks caused by the sub-woofer bass can also affect the display image.

For the foregoing reasons, there is a need for solving problems of a space requirement due to a physical limitation and shocks caused by a sub-woofer integrated into a thin display.

### SUMMARY

It is therefore an objective of the present invention to provide a stand with a sub-woofer for the sub-woofer to be integrated into a thin display without a need for an extra space.

It is another objective of the present invention to provide a thin display stand with a sub-woofer for reducing a shock caused by the sub-woofer to the stand body.

In accordance with the foregoing and other objectives of the present invention at least includes a sub-woofer, a stand body, a damper and a fastener. The damper is disposed between the sub-woofer and the stand body and is coupled with both so that the sub-woofer and the stand body are prevented from contacting each other, and a shock caused by the sub-woofer is absorbed. The fastener is adapted for fixing the damper.

In a preferred embodiment, the fastener is a screw or a bolt and the damper is a washer having a lateral concavity and a passage for the fastener to pass through. The sub-woofer has a coupling part coupled with the lateral concavity.

In conclusion, the invention allows an integration of a sub-woofer with a stand body and also reduces or even eliminates a shock caused by the sub-woofer through a damper so that the entire thin display is not affected and a good integration is available.

It is to be understood that both the foregoing general description and the following detailed description are by examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram of a thin display stand with a sub-woofer in accordance with a preferred embodiment of the present invention;

FIG. 2 is an exploded view of the thin display stand in FIG. 1; and

FIG. 3 is an enlarged cross-sectional view of a portion of the thin display stand in FIG. 2.

### DESCRIPTION OF THE PREFERRED EMBODIMENTS

The present invention discloses a thin display stand integrated with a sub-woofer, effectively utilizing a space to position the sub-woofer and reducing a shock caused by the sub-woofer. Reference will now be made in detail to the present preferred embodiments of the invention, examples of which are illustrated in the accompanying drawings. Wherever possible, the same reference numbers are used in the drawings and the description to refer to the same or like parts.

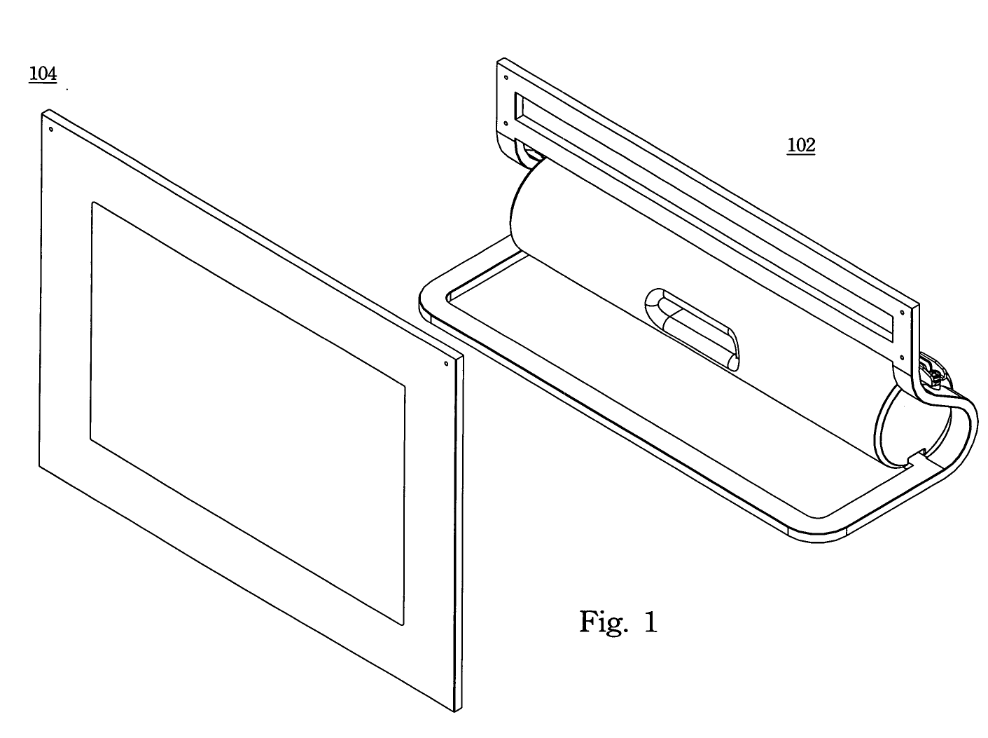

FIG. 1 is a schematic diagram of a thin display stand with a sub-woofer in accordance with a preferred embodiment of the present invention. The figure shows that a thin display apparatus includes a panel 104 and a thin display stand 102.

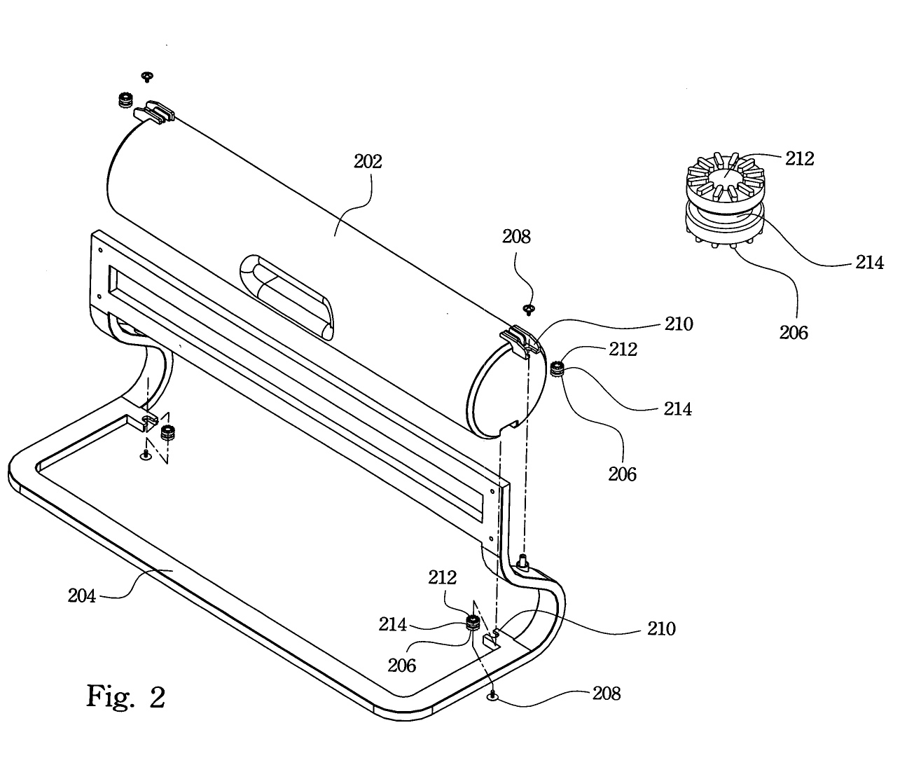

FIG. 2 is an exploded view of the thin display stand in FIG. 1. The thin display stand with a sub-woofer includes a sub-woofer 202, a stand body 204, a damper 206 and a fastener 208. The damper 206 with a plurality of projections is disposed between the sub-woofer 202 and the stand body 204 and is coupled with both so that the stand body 204 is prevented from contacting the sub-woofer 202, such that a shock caused by the sub-woofer 202 is absorbed. The fastener 208 is adapted for fixing the damper 206 on the stand body 204.

In the present embodiment, the fastener 208 is a screw or a bolt. A washer with a passage 212 and a lateral concavity 214 is used as the damper 206, which is an elastic material such as rubber or silicone. The passage 212 is for the fastener 208 to pass through. The sub-woofer 202 includes a concave-shaped coupling part 210 coupled with the lateral concavity 214 of the damper 206. Through a coupling between the coupling part 210 and the damper 206, the sub-woofer 202 is structurally related to the stand body 204 and a shock from the sub-woofer 202 is transferred to the damper 206.

A portion of the coupling part 210 is enclosed by the damper 206 so that a shock caused by the sub-woofer 202 is transferred through the coupling part 210 to the damper 206 instead of being transferred to the stand body 204 directly. Therefore, a shock on the thin display is reduced or even eliminated.

Still referring to FIG. 2, the coupling part 210 can be on the sub-woofer 202 or the stand body 204. In this case, the damper 206 is coupled with the sub-woofer 202 and is fixed thereon by the fastener 208. The coupling part 210 of the stand body 204 is coupled with the lateral concavity 214 of the damper 206.

A shock caused by the sub-woofer 202 is absorbed by the damper 206 similarly and the fastener 208 is also coupled with the damper 206 so that the stand body 204 is not affected directly. In the present embodiment, it is merely used as an example that four sets of dampers 206 and fasteners 208 are applied and the present invention is not limited thereto. One or more sets may also achieve the same purpose.

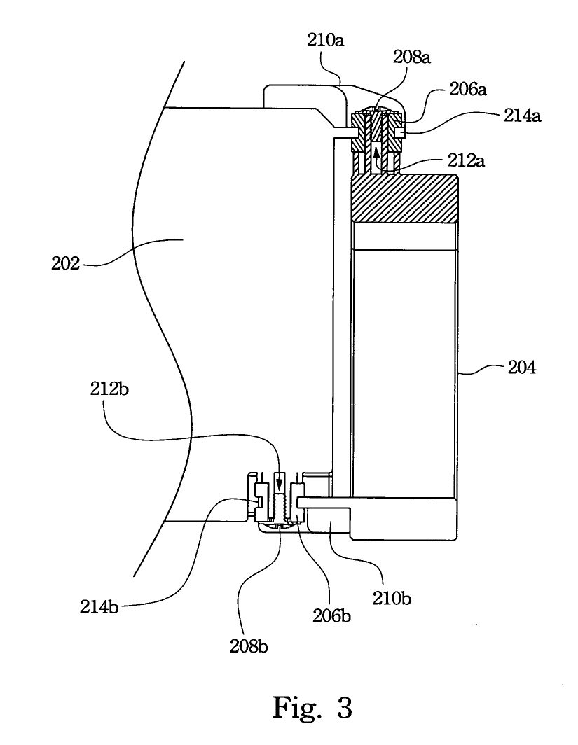

FIG. 3 is an enlarged cross-sectional view of a portion of the thin display stand in FIG. 2. In the case of the coupling part 210 being on the sub-woofer 202, the coupling part 210a of the sub-woofer 202 is coupled with the lateral concavity 214a of the damper 206a and a portion of the fastener 208a passes through the passage 212a. The damper 206a is fixed on the stand body 204 by the fastener 208a so that the sub-woofer 202 is prevented from contacting the stand body 204, such that considerable shock absorption is provided.

Further, in the case of the coupling part 210b being on the stand body 204, the coupling part 210b is coupled with the lateral concavity 214b of the damper 206b and a portion of the fastener 208b passes through the passage 212b. Similarly, the damper 206b is fixed on the stand body 204 by the fastener 208b so that the sub-woofer 202 is prevented from contacting the stand body 204, such that the sub-woofer 202 is provided with a buffer.

Although the present invention has been described in considerable detail with reference to certain preferred embodiments thereof, other embodiments are possible. For example, the invention does not limit forms of the fastener and the damper to those in the embodiment; any kind of fixing and damping mechanisms achieving the same purpose can be used in the invention.

Moreover, the shapes of various components in the invention are not limited to the ones shown in the drawings. The components with any shapes can be used as long as they have the functions described in the specification. Such modifications should be considered as part of the invention. Therefore, the spirit and scope of the appended claims should not be limited to the description of the preferred embodiments contained herein.

It can be known from the aforementioned preferred embodiment of the present invention, the present invention has the following advantage. The invention provides an integration of a sub-woofer with a stand body so that an extra space is not required and shock absorption by a damper is also presented to avoid a shock transferring directly to a stand body.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A thin display stand with a sub-woofer, comprising:
a sub-woofer;
a stand body;
a damper coupled between the sub-woofer and the stand body for absorbing a shock from the sub-woofer; and
a fastener for fixing the damper.

2. The stand of claim 1, wherein the fastener is a screw or a bolt.

3. The stand of claim 2, wherein the damper has a lateral concavity and a passage for the fastener to pass through.

4. The stand of claim 3, wherein the sub-woofer further comprises a coupling part coupled with the lateral concavity.

5. The stand of claim 3, wherein the stand body further comprises a coupling part coupled with the lateral concavity.

6. The stand of claim 1, wherein said damper is made of an elastic material.

7. The stand of claim 6, wherein said elastic material is rubber or silicone.

8. A thin display with a function of performing bass effect, comprising:
a stand body;
a sub-woofer;
a damper coupled between the sub-woofer and the stand body for absorbing a shock from the sub-woofer and having a passage and a lateral concavity; and
a fastener for fixing the damper wherein a portion of the fastener passes through the passage;
wherein the sub-woofer or the stand body comprises a coupling part coupled with the lateral concavity.

9. The thin display of claim 8, wherein the fastener is a screw or a bolt.

10. The thin display of claim 8, wherein the damper is made of an elastic material.

11. The thin display of claim 10, wherein the elastic material is rubber or silicone.
